(19) United States
(12) Patent Application Publication
(10) Pub. No.: US 2006/0164712 A1
(43) Pub. Date: Jul. 27, 2006

(54) Optical transmitter capable of prompt shutting down and recovering optical output thereof

(76) Inventor: Hiroto Ishibashi, Kanagawa (JP)

Correspondence Address: SMITH, GAMBRELL & RUSSELL, LLP, 1850 M STREET, N.W., SUITE 800, WASHINGTON, DC, 20036, US

(21) Appl. No.: 11/324,799

(22) Filed: Jan. 4, 2006

(30) Foreign Application Priority Data
Jan. 5, 2005 (JP) P.2005-000896

(51) Int. Cl. G02F 1/01

(52) U.S. Cl. 359/239

(57) ABSTRACT

The present invention discloses an optical transmitter that enables a prompt stopping and restarting of an optical output power thereof. The transmitter includes a laser diode, a driver, an output monitor, and a controller. These constitute an auto-power-control (APC) loop. The APC loop of the present invention further includes a switch that supplies the output of the controller in an ordinary state. When receiving a shutting down command, the switch supplies a signal to stop the optical output of the LD, while the controller maintains the output thereof corresponding to a value which the APC loop is to be set when the shutting down command is negated.

### BACKGROUND OF THE INVENTION

1. Filed of the Invention

The present invention relates to an optical transmitter.

2. Related Prior Art

Various prior arts have disclosed an optical transmitter with a semiconductor laser diode digitally controlled in its optical outputs. For example, PCT Publication, WO98/013958, has disclosed an optical transmitter with a central processing unit (CPU), connected to a driver for the laser diode through a digital-to-analog converter D/A-C, which supplies a analog value converted from a digital value set by the CPU. The driver supplies a driving current, which corresponds to the analog value provided from the D/A-C, to the LD. When receiving a shutting down signal for stopping the optical output from the LD, the CPU sets a digital value to the D/A-C so as to become the driving current of the LD to be zero to stop the optical output therefrom. Further, when the shutting down signal is negated, the CPU changes the digital value to be set in the D/A-C to increase the optical output from the LD.

On the other hand, the multi-source agreement for the small form factor pluggable (SFP) transceiver rules the shutting down time t_off, from asserting the shutting down signal to the practical ceasing of the optical output from the LD, to be as longer as 10 μs, and the recovering time t_on, from negating of the shutting down signal to the optical output of the LD with a preset magnitude, to be 1 ms maximum.

When the process corresponding to the asserting or negating of the shutting down signal is performed only by the interruption, is hard to satisfy the condition ruled in the above MSA, because when asserting the shutting down signal, it is necessary to take a comparable time from starting the interruption to setting a digital value in the D/A-C. Using a CPU with a clock frequency of 25 MHz and a D/A-C with a standard specification, it takes 5 μs from starting the interruption to setting a digital value in the D/A-C in addition to 10 μs from setting of the digital value to outputting an analog value corresponding to the digital value by the D/A-C. Moreover, for the negating of the shutting down signal, in addition to the time from starting the interruption to setting a digital value in the D/A-C, it takes several loops of the auto power control (APC) to obtain an optical output of the LD within a preset range.

Therefore, the present invention is to provide an optical transmitter that enables a prompt stopping and restarting of the optical output of the LD.

### SUMMARY OF THE INVENTION

One aspect of the present invention relates to an optical transmitter that includes a laser diode, a monitoring circuit, a controller, a driver, and a switching means. These elements constitute a closed feedback loop for the automatic power control (APC) of an optical output of the laser diode. The monitoring circuit generates a monitored signal that corresponds to the optical output of the laser diode. The controller, by receiving this monitored signal, generates a control signal to maintain the optical output in a reset magnitude. The driver drives the laser diode. The switching means has one output and two inputs. The output is connected to the driver, while one of inputs is connected to the controller and the other of inputs is connected to a signal with a level to stop the optical output of the laser diode. The switching means, by asserting a shutting down signal provided from an outside of the transmitter, connects the signal to stop the optical output to the driver, while the controller generates an initial signal of the control signal during the switching means cuts the closed feedback loop off.

Since the present transmitter switches the control signal, in response to the shutting down signal, to the signal to stop the optical output of the laser diode, the optical output is promptly ceased, and to the control signal generated by the controller from the signal to stop the optical output when the shutting down flag is negated, the optical output of the laser diode is promptly to set a preset magnitude. Moreover, since the control signal may set the driving current of the laser diode, not the reference of the APC loop, the APC loop does not show any overshoot or undershoot in the optical output to shorten the recovering time from the negation of the shutting down signal to a time when the optical output becomes within a preset range.

As long as the shutting down signal is asserted, the controller continues to provide an initial condition for the closed feedback loop to the one of the input of the switching means. Subsequently, when the shutting down signal is negated, the switching means provides this initial condition to the driver to recover the closed feedback loop. The initial condition reflects the magnitude of the driving current for the laser diode, which eliminates the loop iteration to obtain the optical output within the preset range and promptly stabilizes the optical output compared with a conventional transmitter, in which the initial condition of the closed loop is reset to zero.

The initial condition may depend on a temperature of the transmitter. The controller may install a memory to store the initial condition in connection with the temperature. When the shutting down signal is asserted and the closed loop is cut off, the controller may sense the temperature of the transmitter and may read the initial condition from the memory corresponding to the sensed temperature. Accordingly, even when the temperature changes while the optical output is ceased, the controller may provide the initial condition reflecting the current temperature of the transmitter to the driver, which prevents the laser diode from outputting in an excess magnitude and from breaking down.

### BRIEF DESCRIPTION OF DRAWINGS

FIG. 1 is a block diagram of the transmitter according to the present invention;

FIG. 2 is a flow chart of the process to control the optical output of the transmitter of the present invention;

FIG. 3 is a flow chart showing the interrupt process when the shutting down signal is asserted;

FIG. 4 is a flow chart showing the process when the shutting down signal is negated;

FIG. 5 is a time chart when the shutting down signal is asserted;

FIG. 6 shows a configuration of the look-up-table;

FIG. 7 is a time chart when the shutting down signal is negated;

FIG. 8 shows a block diagram of the conventional optical transmitter;

FIG. 9 is a flow chart showing the process for controlling the optical output in the conventional transmitter;

FIG. 10 is a time chart of the conventional transmitter when the shutting down signal is asserted;

FIG. 11 shows a flow chart of the conventional transmitter when the shutting down signal is asserted;

FIG. 12 is a time chart of the conventional transmitter when the shutting down signal is negated; and

FIG. 13 shows a flow chart showing an interruption process of the conventional transmitter when the shutting down signal is negated.

### DESCRIPTION OF PREFERRED EMBODIMENTS

Next, preferred embodiments of the present invention will be described as referring to accompanying drawings. In the drawings, same numerals or symbols will refer to the same elements without overlapping explanations.

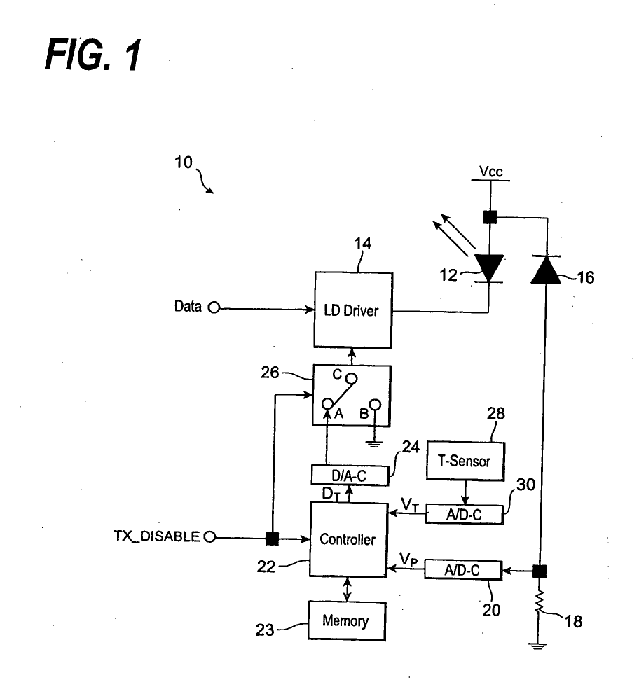

FIG. 1 is a block diagram of an optical transmitter 10 according to one embodiment of the present invention. The transmitter 10 provides a function to shut down an optical output, namely, the optical output from the transmitter is forced to be shut down by some reasons such as anomaly of the operation of the transmitter 10. The shutting down of the optical output is triggered by a signal denoted as the TX_DISABLE in FIG 1. When the TX_DISABLE becomes active, the optical output is prohibited, on the other hand, it is allowed when the TX_DISABLE is kept inactive. To set the TX_DISABLE active is called as “Assertion” of the shutting down signal, while to set the TX_DISABLE inactive is called as “Negation”.

The optical transmitter 10 includes a laser diode (hereinafter denoted as LD) 12, a driver 14 for driving the LD, a photodiode (PD) 16 for monitoring the optical output of the LD 12, a reference resistor 18, an analog-to-digital converter (A/D-C) 20, a controller 22, a memory 23, a digital-to-analog converter (D/A-C) 24 and a switch 26. The LD 12 and the PD 16 are biased in forward and in reverse, respectively, by supplying with a power supply V_{cc}. The A/D-C 20, the controller 22, and the D/A-C 24 constitute a signal processing unit, while the PD 16 and the reference resistor 18 constitute a monitoring circuit.

The LD 12 generates an optical output by receiving a driving current from the driver 14. There are two kinds of driving current; one is the bias current while the other is the modulation current. The modulation current is modulated by a data input to the driver 14 from the outside of the transmitter 10. The magnitude of the bias and modulation currents may be determined by the signal input to the control terminal of the driver 14. This control terminal of the driver 14 is connected to the switch 26.

The PD 16, by receiving a portion of the optical output from the LD 12 generates a photo current depending on the magnitude of optical output from the LD. The anode of the PD 16 connects to the reference resistor 18 to generate an analog voltage proportional to the photo current. The A/D-C 20 converts this voltage signal into a digital value Vₚ to send to the controller 22. The digital value Vₚ corresponds to the optical output from the LD 12.

The controller 22 controls the operation of the transmitter 10. That is, the controller 22 carries out an automatic power control (APC) to maintain the optical output of the LD 12 in a preset magnitude. The APC is a closed feedback loop process, namely, it is configured to compare the monitored optical output Vₚ with a preset value, and to adjust the bias and modulation currents such that the monitored optical output Vₚ becomes identical with the preset value.

The D/A-C 24 includes a register accessible from the controller 22. The digital signal to determine the bias and modulation currents is to be stored within this register. The D/A-C 24 converts this digital signal into a corresponding analog form to transmit it to the switch 26.

The switch 26 has one output terminals C and two input terminals, A and B. The terminal A connects the output of the D/A-C 24, while the terminal B is grounded. The terminal C connects to the control terminal of the driver 14. The switch 26, depending on the TX_DISABLE, connects the terminal C to one of the terminal A or the terminal B. That is, when the shutting down signal is negated, the terminal C is connected to the terminal A. Consequently, the driver 14 receives in its control terminal the analog signal from the D/A-C 24 to provide the bias and modulation currents depending on this analog signal to the LD 12. On the other hand, when the shutting down signal is asserted, the switch 26 connects the terminal C to the terminal B to ground the control terminal of the driver 14 and, consequently, the ground potential is supplied to the control terminal of the driver 14 as the analog control signal. When the control terminal of the driver 14 is grounded, the driver 14 sets the bias and modulation currents zero to switch the LD 12 off. As a result, the optical output from the LD 12 is shut down.

The optical transmitter 10 further includes a temperature sensor 28 and another A/D-C 30. The temperature sensor 28 monitors an inner temperature of the optical transmitter 10 and outputs an analog signal indicating the temperature thereof. The A/D-C 30 converts this analog signal into a digital value V_{T} to output the controller 22. This digital value V_{T} denotes the inner temperature of the transmitter.

The controller 22 provides a memory 23 that stores a look-up-table (LUT) in which various parameters of the LD 12 are held in connection with temperatures of the LD 12. The LUT is accessed to adjust the control signal set to the D/A-C 24 in accordance with temperatures, which is explained in detail later.

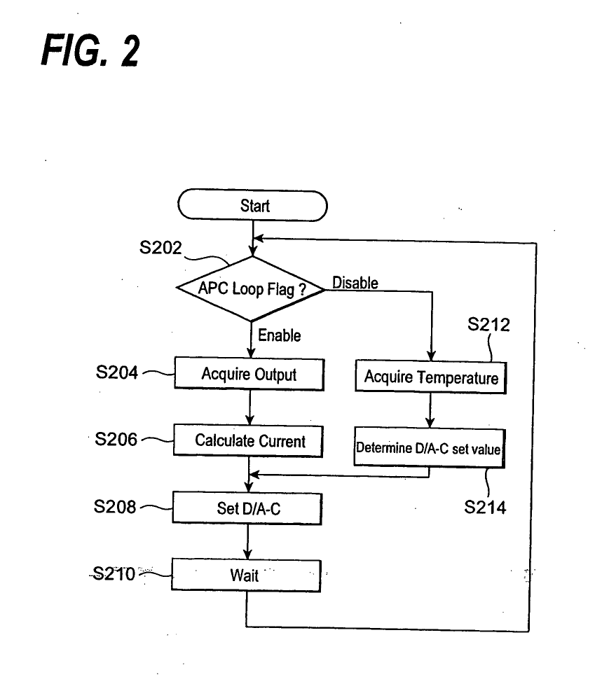

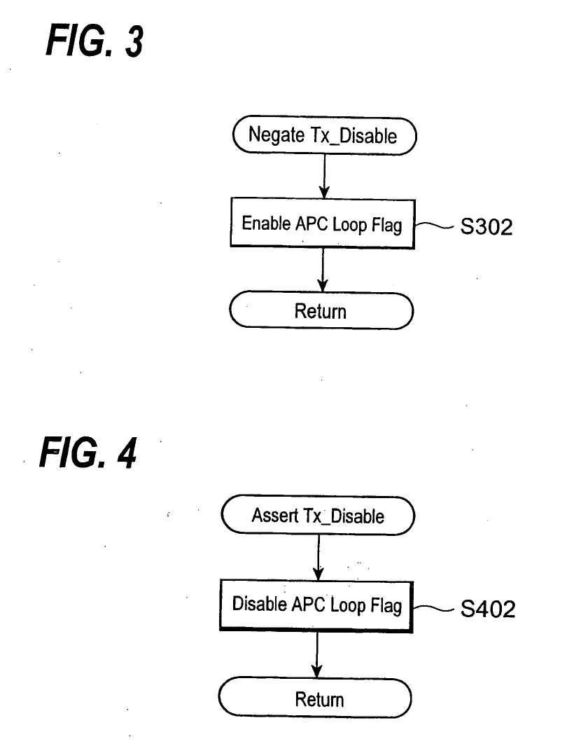

FIG. 2 is a flow chart showing a process to adjust the optical output from the LD 12 by the controller 22. First, the controller 22 checks the APC loop flag stored within the controller 22 at a step S202. Receiving the shutting down signal from the outside of the transmitter, the controller 22 executes an interrupt routine and changes the APC loop flag depending on the shutting down signal. That it, when the shutting down signal is negated and the transmitter 10 operates in an ordinary state, the controller 22 continues the ordinal process, as shown in FIG. 3, to enable the APC loop flag at step S302. On the other hand, when the shutting down signal is asserted and the optical output of the transmitter 10 is interrupted, the controller executes the interrupt process shown in FIG. 4 to disable the APC loop flag at step S402.

When the APC loop flag is enabled, the controller executes the APC loop, namely, the controller 22 acquires the present optical output via the A/D-C 20, at step S204, compares this optical output with a reference value to obtain a digital value to set the bias and modulation currents, as step S206, and sends this digital value to the D/A-C 24, at step S208. Subsequently with a preset waiting at step S210, the controller executes the step S202 again. As long as the shutting down signal is negated, the controller iterates the sequence of steps from S204 to S210 to maintain the optical output in the preset power.

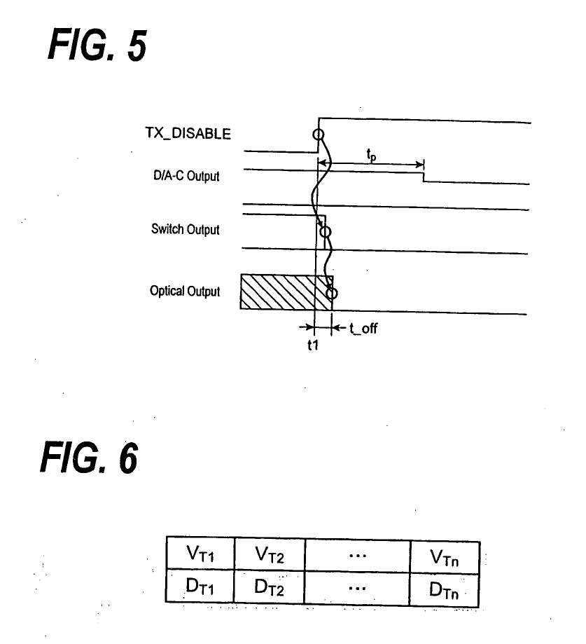

FIG. 5 is a time chart showing a case when the shutting down signal is asserted during the ordinary APC operation. As shown in FIG. 5, asserting the shutting down signal at tl, the switch 26 changes the output thereof to the ground level to stop the optical output from the LD 12. Simultaneously, by the interruption process shown in FIG. 4, the APC loop flag is disabled. In this situation that the APC loop flag is disabled, the steps S204 and S205 in FIG. 4 are unexecuted. That is, the controller 22 stops the APC loop. The reason why the APC loop is stopped responding to the assertion of the shutting down signal is, when the optical output is ceased, its monitored value becomes zero and the difference from the reference value becomes quite large. Therefore, the controller 22 will send the large control signal to the D/A-C 24 to flow the large bias and modulation current in the LD 12 if the APC loop is not stopped, which may make the LD 12 to emit light with excess magnitude and may sometimes cause the breakdown thereof.

The characteristic of the LD 12, in particular the relation between the optical output power against the current to be supplied thereto, strongly depends on the temperature. Generally, when the LD is driven so as to maintain the optical output power thereof constant, the larger current is necessary in high temperatures as compared to cases in low temperatures. For example, when the shutting down signal is asserted in the high temperature, the temperature falls as the control signal set in the D/A-C 24 is held, and the shutting down signal is negated in the low temperature, a large driving current based on the control signal set in the D/A-C 24 may flow in the LD 12, which may break down the LD 12. Therefore, it is preferable that the initial driving current when the APC loop is re-started by the negation of the shutting down signal is a value depending of the then temperature of the LD 12 not the value at the assertion of the shutting down signal.

Therefore, the present invention sets the digital value provided to the D/A-C 24 such that, by sensing the inner temperature of the transmitter 10 during the assertion of the shutting down signal, the bias and modulation currents corresponding to the inner temperature will be supplied to the LD 12 when the shutting down signal is negated. That is, the controller 22 sets the control signal provided to the D/A-C 24 to be one of a digital value within the LUT stored in the memory 23. The period necessary for the controller 22 to set the control signal in the D/A-C 24 is denoted as tₚ in FIG. 5.

Specifically describing the aforementioned algorithm, when the controller 22 confirms the disablement of the APC loop flag at step S210 in FIG. 2, the controller 22 acquires the signal corresponding to the inner temperature of the transmitter via the A/D-C 30 at step S212 and defines the control signal to be set in the D/A-C 24 at step S208, by comparing this acquired signal and a value stored in the LUT.

FIG. 6 schematically shows a configuration of the LUT in the memory 23. This LUT sets a sequence of digital values, D_{Tl}˜T_{TN}, which determines the magnitude of the bias and modulation currents, in accordance with digital values, V_{Tl}˜V_{TN} (N is integer), which corresponds to temperatures Tₗ to T_{N}. Temperatures, T₁ to T_{N}, may have a constant interval, for example 2° C. Values, D_{Ti}, are decided based on the characteristic for each LD 12 such that the optical output becomes the preset power when the inner temperature of the transmitter is Tᵢ. When the sensed temperature does not coincide with any temperatures indexed for the LUT, a value D_{Ti} corresponding to the indexed temperature closest to the sensed temperature may be used as the control signal set in the D/A-C 24, or, a value Dᵢ just corresponding to the sensed temperature Tᵢ may be calculated by the interpolation or the extrapolation of values D_{Ti} in the LUT.

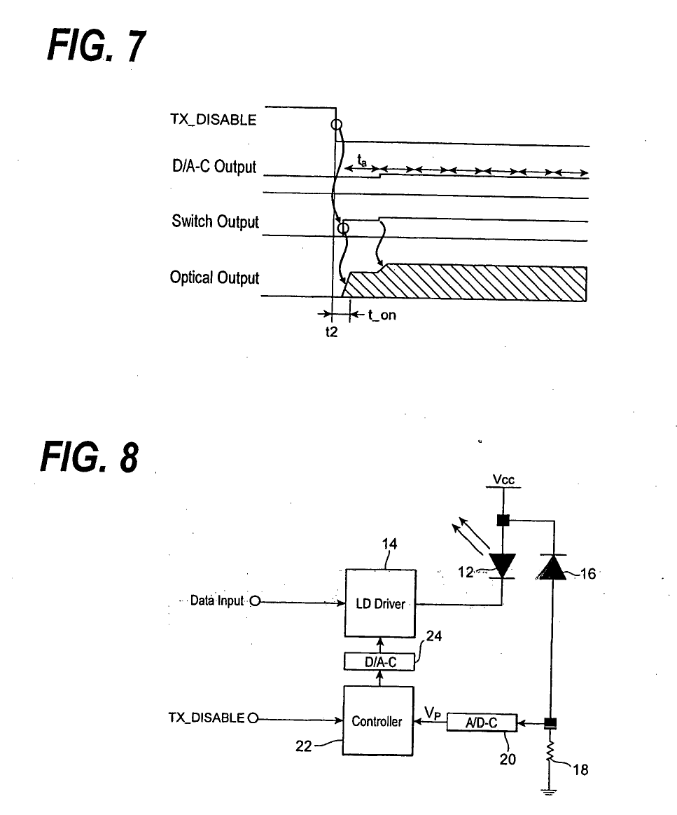

FIG. 7 is a time chart when the shutting down signal is negated at t2 during the optical output is stopped. As shown in FIG. 7, when the shutting down signal is negated, the controller 22 enables the APC loop flag and restarts the APC loop. The switch 26, by connecting the terminal A to the terminal C, supplies an analog signal output from the D/A-C 24 to the LD driver 14. This analog signal, as explained, is converted from the control signal set by the processes from S214 and S208 mentioned in FIG. 2, and accordingly, has a magnitude to emit light with the preset power and extinction ratio for the inner temperature of the transmitter 10. Immediately after the restarting of the APC loop, the driver supplies the bias and modulation currents corresponding to this analog signal. Subsequently, the APC loop operates such that the light emitted from the LD 12 approaches the preset value in the magnitude and extinction ratio thereof.

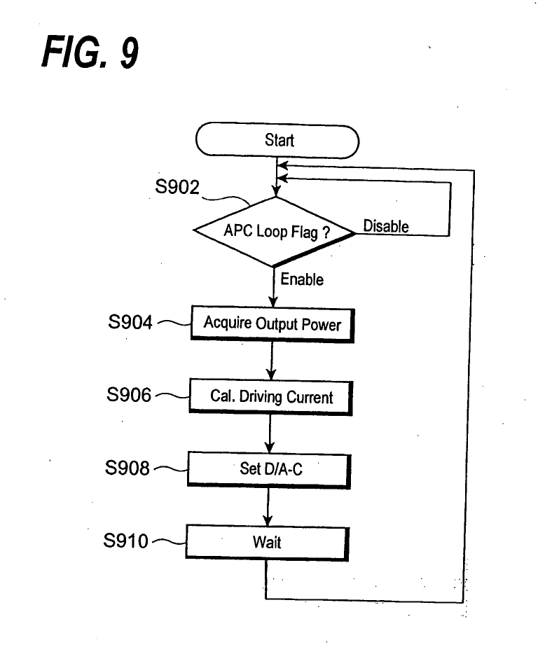

Next, the present invention will be compared with conventional transmitters. FIG. 8 is a block diagram of the conventional optical transmitter, which is distinguished from the transmitter of the present invention in a sense that the conventional one does not provide the memory 23, the switch 26, the temperature sensor 28, and the A/D-C 30. FIG. 9 is a flow chart of the conventional transmitter shown in FIG. 8. The controller 22 first checks the APC loop flag at step S902. When the APC loop flag is active, the controller 22 prosecutes, similar to the present invention, steps from S904 to S910, which is the closed feedback loop of the APC.

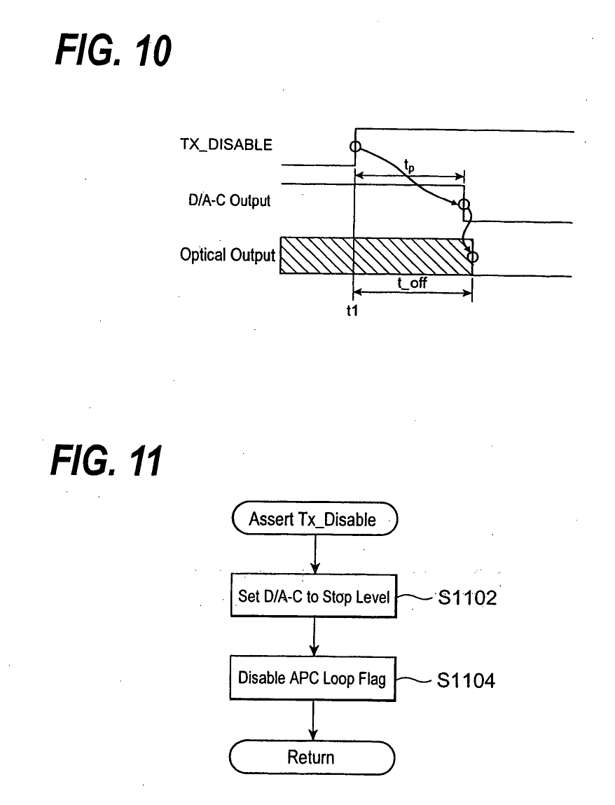

In this conventional transmitter, the optical output is stopped or restarted only by the APC loop flag. FIG. 10 is a time chart for the conventional transmitter when the shutting down signal is asserted during the ordinary operation. Asserting the shutting down signal, the controller 22 prosecutes the interruption process shown in FIG. 11. That is, the controller 22 sets the control signal provided to the D/A-C 24 to a level for stopping the optical output at step S1102, and the analog value converted from this control signal sets the driving current for the LD 12 to be zero. Thus, by executing the step S1102, the optical output is stopped. In the same time, the controller 22 sets the APC loop flag in a disabled state at step S1104. As shown in FIG. 9, during the disablement of the APC loop flag, the APC loop is inactive, and the controller iterates the checking of the APC flag at step S904.

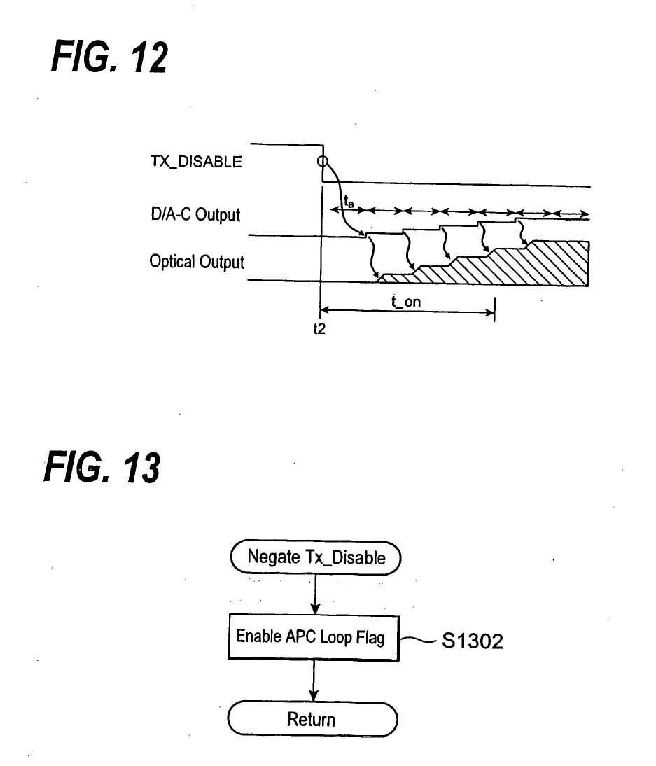

FIG. 12 is a time chart when the shutting down signal is negated at t2 during the stop of the optical output. Negating the shutting down signal, the controller prosecutes the interruption shown in FIG. 13, which sets the APC loop flag to be active at step S1302. Thus, the APC loop is restarted and the optical output increases to the preset value.

As shown in FIG. 10, the shutting down time t_off from the assertion of the shutting down signal to the practical stopping of the optical output power becomes comparably long because the controller 22 takes a processing time tp to set a control signal in the D/A-C 24 for changing the optical output to the stopped level. Contrary, as shown in FIG. 5, the present transmitter promptly changes the analog signal to the ground level, which is to be input in the LD driver 14, by the switch 26 without completing the setting of the control signal to the D/A-C 24, which shortens a time for stopping the optical output.

Moreover, as shown in FIG. 12, the conventional transmitter iterates the APC loop with the cycle of tₐ for recovering the output of the D/A-C 24 from the stopped level to a preset level of the optical output when the shutting down signal is negated, which is the time t_on for recovering the optical output from the negating of the shutting down signal to the time when the optical output becomes within the present range. Contrary, as shown in FIG. 7, the present transmitter promptly changes the analog signal input to the driver 14 by the switch 26. Moreover, the output of the D/A-C 24 has a value corresponding to the inner temperature of the transmitter, not the level where the optical output is stopped. Accordingly, the present transmitter is necessary for the APC loops fewer than that necessary in the conventional one, which shortens the recovering time t_on.

Moreover, the present transmitter adjusts the output of the D/A-C 24 during the optical output is stopped, accordingly, the LD 12 may be protected from the over emission or breakdown at the recovery of the optical output.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An optical transmitter, comprising:
a laser diode for generating an optical output;
a monitoring circuit for generating a monitored signal corresponding to the optical output of the laser diode;
a controller for generating a control signal to maintain the optical output in a preset magnitude by receiving the monitored signal;
a driver for driving the laser diode, the laser diode, the monitoring circuit, the controller constituting and the driver constituting a closed feedback loop for an automatic power control for the laser diode; and
a switching means with an output connected to the driver and two inputs, one of which is connected to the controller and the other of which is connected to a signal to stop the optical output of the laser diode by asserting a shutting down signal provided from an outside of the transmitter; and
wherein the controller generates an initial signal of the control signal during the switching means cuts the closed feedback loop off.

2. The optical transmitter according to claim 1,
further includes a temperature sensor for sensing a temperature within the optical transmitter,
wherein the control signal supplied from the controller to the driver is decided based of the temperature sensed by the temperature sensor, and the controller, when the closed feedback loop is cut off, provides the initial signal based on the temperature sensed by the temperature sensor.

3. The optical transmitter according to claim 2,
wherein the controller includes a memory for storing the control signal in connection with the temperatures.

4. A method for controlling an optical output of a laser diode installed in an optical transmitter that includes a driver for driving the laser diode, a monitoring circuit for monitoring the optical output of the laser diode, a controller for controlling the driver by supplying a control signal and a switching means with an output connected to the driver and two inputs, one of which is connected to the controller and the other of which is connected to a signal with a level to stop the optical output of the laser diode, the laser diode, the monitoring circuit, the controller, the switching means and the driver constituting a closed feedback for an automatic power control of the optical output of the laser diode, said method comprising steps of:
asserting a shutting down signal from an outside of the transmitter;
cutting the closed feedback loop off and providing the signal with the level to stop the optical output of the laser diode by the switching means in response to the assertion of the shutting down signal;
generating an initial signal by the controller, the initial signal being supplied to the one of the input of the switching means, and
recovering the closed feedback loop by providing the initial signal provided in the one of the input of the switching means to the driver in response to a negation of the shutting down signal.

5. The method according to claim 4,
further comprises a step of checking an APC loop flag after asserting the shutting down signal and before cutting the closed feedback loop, and disabling the APC loop flag when the APC loop flag is enabled.

6. The method according to claim 4,
further comprises a step of disabling an APC loop flag after cutting the closed feedback loop.

7. The method according to claim 4,
further comprises a step of enabling an APC loop flag after recovering the closed feedback loop.

8. The method according to claim 4,
wherein the optical transmitter further includes a temperature sensor and the method further comprises a step of, after cutting the closed feedback loop off and before generating the initial signal, sensing the temperature of the optical transmitter, the initial signal corresponding to the temperature of the transceiver.

9. The method according to claim 8,
wherein the transmitter further includes a memory in the controller for storing the initial signal in connection with the temperature, and the step of generating the initial signal includes a step of reading the initial signal from the memory by the controller.
